(19) United States
(12) Patent Application Publication
(10) Pub. No.: US 2008/0035779 A1
(43) Pub. Date: Feb. 14, 2008

(54) Automatic Belt Tensioner

(76) Inventors: Wolfgang Guhr, Grundau (DE); Michael Fischer, Fellen (DE)

Correspondence Address: Robin W. Asher;Clark Hill, 500 Woodward Avenue, Suite 3500, Detroit, MI, 48226-3435, US

(21) Appl. No.: 10/584,101

(22) PCT Filed: Oct. 5, 2004
(86) PCT No.: PCT/EP04/11114

§ 371 Date: Apr. 5, 2007

(30) Foreign Application Priority Data
Dec. 22, 2003 (DE) 20319886.7

(51) Int. Cl. F16H 7/12

(52) U.S. Cl. 242/410

(57) ABSTRACT

The invention relates to an automatic belt tensioner comprising a basic part that is connected to a tensioning part so as to be rotatable about a common axis of rotation, a helical spring that is joined to the basic part and the tensioning part, and a wrapping bush which is wrapped at least in some areas with a radial enveloping force by means of the helical spring. According to the invention, the material of the wrapping bush contains reinforced plastic in order to ensure that the belt tensioner provides good damping and good cushioning properties if possible during the entire service life thereof while being universally usable and having a simple design.

The invention relates to an automatic belt tensioner with the characteristics of the preamble of claim 1.

DE 40 10 928 C2 discloses an automatic belt tensioner of this kind for tensioning a belt in a belt-drive system. This way, a tensioned state of the belt is intended to be maintained during the entire service life. The belt is tensioned with a wheel provided on a tensioning arm.

Depending on the application conditions of the automatic belt tensioner, the belt is placed in varying states of vibration by the driving and driven assemblies. The vibrations of the belt are transmitted via the tensioning arm to the housing of the automatic belt tensioner. The helical spring is supported at one end with turns on a wrapping bush, which transmits the forces acting upon it to a spring sleeve. The wrapping bush ensures a more even distribution of the frictional force to the spring sleeve. This way higher torque can be achieved, and the damping action is more effective. The wrapping bush additionally offers effective support for the turns of the helical spring and is actively involved in the damping effect during operation. Despite the friction that occurs during operation, the interacting components are intended to maintain these properties if possible without decreased function.

It is the object of the invention to improve a belt tensioner of this kind such that it provides good damping and good cushioning properties if possible during the entire service life of the belt tensioner, while being universally usable and having a simple design.

This object is achieved according to the invention with a belt tensioner with the characteristics of claim 1.

The enveloping turns of the helical spring can mate very well with the wrapping bush, thus producing a very good force-fit connection. The material of the wrapping bush comprising reinforced plastic is sufficiently tough and wear-resistant compared to the kind of wrapping bush made of non-ferrous metal. This way, any friction occurring at the seams to adjoining components, particularly to the helical spring, can be absorbed during the entire service life of the automatic belt tensioner. The damping properties of the belt tensioner therefore likewise remain substantially the same during the entire service life of the belt tensioner. The wrapping bush is more wear-resistant and remains more dimensionally stable.

According to a particular option, the plastic can be fiber-reinforced. The plastic may comprise particularly glass fibers for reinforcement. The fibers sufficiently reinforce the otherwise soft plastic material so that the helical spring has a good fit and support on the wrapping bush. The wrapping bush, however, remains sufficiently flexible for elastic movements and is more wear-resistant.

Particularly advantageous with this device could be a sphere-reinforced plastic, comprising in particular glass spheres for reinforcement. This embodiment of the invention is suited for high belt tension levels and has lasting, good dimensional stability and wear-resistance properties.

Advantageously, the wrapping bush can accommodate right- and left-handed helical springs. This way, the same wrapping bush can be universally equipped with left- or right-handed helical springs, depending on the tensioning direction at the installation location.

In a particular variant, a peripheral edge of the wrapping bush may comprise inclines corresponding to the course of a left-handed turn in one area and that of a right-handed turn in another area. The peripheral edge supports potential spring turns of the helical spring sufficiently well, and the generated enveloping force can be transmitted to the wrapping bush with the least possible loss of force and torque.

In a particularly advantageous embodiment of the automatic belt tensioner, the helical spring can envelope the wrapping bush with less than one full turn, particularly with more than or equal to a half or 0.7 turn. This way, a sufficiently large contact area of the radial enveloping force on the wrapping bush is guaranteed. Contrary to expectations, this small wrapping area suffices in order to maintain the belt tension as continuously as possible on the one hand and in order to produce sufficiently great stability and friction on the adjoining components for vibration damping purposes on the other hand.

In another variant of the invention, the wrapping bush may comprise a chamfered peripheral edge on the free end. This chamfered configuration ensures smooth action of the spring turn on the wrapping bush.

In a particularly advantageous variant of the automatic belt tensioner, the wrapping bush envelopes a spring sleeve at least in some areas and the spring sleeve comprises at least one recess on the circumference, which recess engages with a step provided in the spring sleeve in the circumferential direction and/or axial direction. This way, the wrapping bush is fixed in place so as to resist axial displacement in relation to the spring sleeve and/or so as to resist rotational movements.

A special option may be provided if the step of the spring sleeve comprises an inclined surface in the axial direction, which surface widens the wrapping bush up to the engagement position during assembly. This ensures that the wrapping bush easily slides on the spring sleeve.

In another variant of the invention, at least one retaining step may be provided on the free end opposite the peripheral edge of the wrapping bush, which step engages in a recess provided in the spring sleeve to resist rotational movements.

### This way, the wrapping bush is fixed non-rotationally in its position in relation to the spring sleeve.

In a particularly advantageous design, the spring sleeve may comprise at least one depression for receiving a lubricant on the inside. As a result of the depression, sufficient lubricant may be stored and provided during the entire service life of the belt tensioner. The supply of the lubricant on the inside of the spring sleeve favors the friction and damping behaviors to the adjoining component.

The depression may extend particularly in the axial direction, and it may particularly have a design that is notched in its cross-section. Sufficient lubricant is applied to the inside of the spring sleeve across the entire length.

### Due to the notched depression, a sufficiently large lubricant supply and/or lubricant feed volume for vibration damping are provided.

Advantageously, a spring sleeve enveloped at least in some areas by the wrapping bush may comprise a supporting base collar, which may be broken down into several areas distributed across the circumference. The base collar may support the spring sleeve in relation to the basic part on the components attached thereto in a very stable manner in terms of shape and position and due to the small amount of material that is required does not result in significantly added weight.

In another variant of the invention, a spring sleeve surrounded at least in some areas by the wrapping bush may comprise a supporting base collar, wherein at least one area of the base collar comprises a projecting spring end support.

### This way, a free spring end of the helical spring is supported very well up to a detent area of the spring ends in the basic part.

In another variant of the invention, the wrapping bush surrounds a spring sleeve at least in some areas, wherein the wrapping bush and the spring sleeve are produced together in a multi-component tool.

The drawing illustrates an exemplary embodiment of the invention, which is explained in more detail hereinafter, wherein:

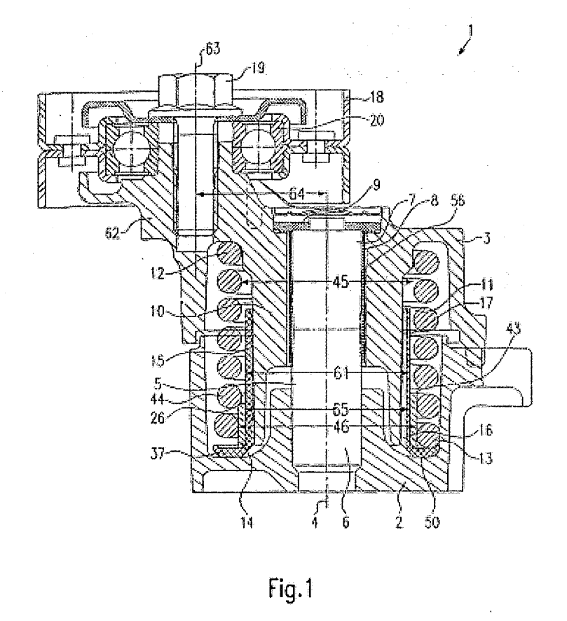

FIG. 1 is a sectional drawing of an automatic belt tensioner according to the invention,

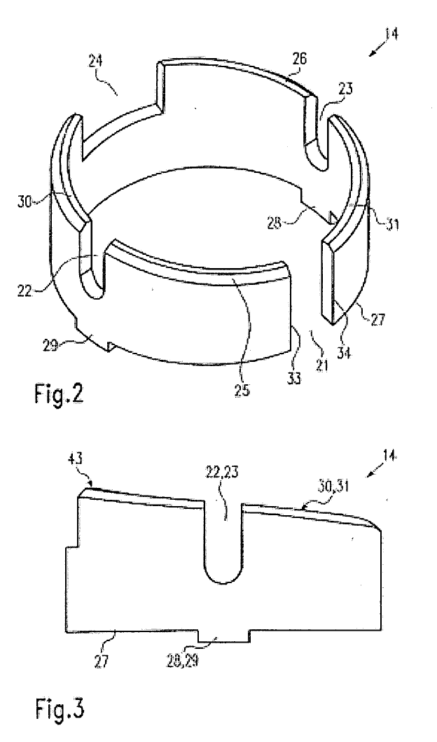

FIG. 2 is a perspective view of a wrapping bush of a belt tensioner according to the invention,

FIG. 3 is a lateral view of the wrapping bush from FIG. 2,

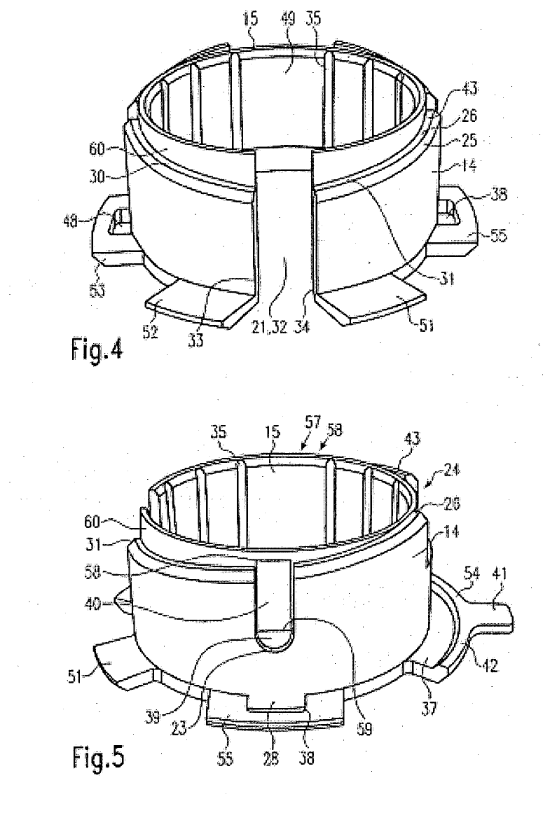

FIG. 4 is a perspective illustration of a wrapping bush and a spring sleeve according to the invention in the assembled state,

FIG. 5 is a perspective illustration of the spring sleeve with the wrapping bush in a view rotated by 90° in relation to FIG. 4, and

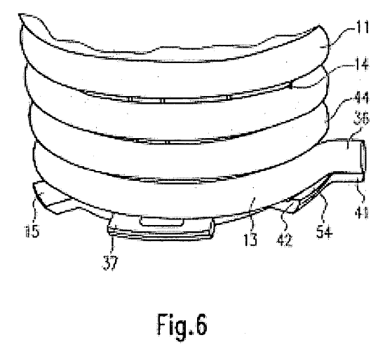

FIG. 6 is a perspective illustration of individual turns of a helical spring, which surrounds the wrapping bush placed on the spring sleeve.

FIG. 1 shows an assembly of the automatic belt tensioner 1 according to the invention.

It shows a basic part 2, which can be rotated relative to a tensioning part 3 about a common axis of rotation 4. The common axis of rotation 4 extends centrically in the axial direction in a bolt 5. One end 6 of the bolt 5 is firmly connected to the basic part 2. On the opposite end 7 of the bold 5, a pressed-on flange sleeve 8 is held in place with the help of a washer 9.

The tensioning part 3 has a pot shape with an inner wall 10. The inner wall 10 has an inside 56 and an outside 17. The tensioning part 3 is connected to the flange sleeve 8 on the inside 56 so as to be able to rotate about a common axis of rotation 4.

A helical spring 11 is disposed around the outside 17 of the inner wall 10 of the tensioning part 3. The turn 12 of the helical spring 11 is engaged on one spring end with the tensioning part 3 and supported thereon.

On the other spring end, the last turn 13 is connected to the basic part 2 on the opposite side of the helical spring 11 and supported thereon.

The helical spring 11 surrounds a wrapping bush 14 with slightly more than one turn 13, 44. The remaining turns have no contact with the wrapping bush and the spring sleeve 15.

The wrapping bush 14 surrounds the spring sleeve 15 and rests against it. The outside diameter 46 of the wrapping bush 14 is about 1 mm larger than the inside diameter 45 of the helical spring 11 in the relaxed state. Due to the larger outside diameter 46 of the wrapping bush 14, the helical spring 11 is pre-stressed in the illustrated assembled state.

The inside of the spring sleeve 16 is connected to the outside 17 of the wall 10 of the tensioning part 3 in a frictionally engaged manner. The spring sleeve 15 is supported with a base collar 37 on the bottom surface 50 in relation to the basic part 2.

A tension pulley 18 is rotatably connected to a deflecting arm 62 formed on the tensioning part 3 via a radial bearing 20 with the help of a screw 19. The deflecting arm 62 is disposed in a parallel spaced manner in the axial direction from the common axis of rotation 4. As a result, a lever arm 64 is geometrically formed, the lever length of which is the distance between an axis of rotation 63 of the tension pulley 18 and the common axis of rotation 4.

FIG. 2 shows a perspective view of a wrapping bush 14, which is made of sphere-reinforced plastic. The glass sphere reinforcement produces increased rigidity and increased stability of the wrapping bush 14.

On the periphery, the wrapping bush 14 comprises in the axial direction a continuous slot 21. The slot 21 is formed by a lateral left edge 33 and a lateral right edge 34. The wrapping bush 14 on the free end thereof 43 has a chamfered outer peripheral edge 26. The chamfered peripheral edge 26 is interrupted with several recesses 22, 23, 24 and one chamfer 25.

The recesses 22, 23 have the contour of an elongated hole and are disposed diametrically symmetrically opposed in the axial direction in the periphery of the wrapping bush.

Another recess 24 has a more rectangular contour, which is disposed diametrically symmetrically opposed to the slot 21 in the axial direction on the periphery of the wrapping bush 14.

The chamfer 25 extends across the entire circumference of the wrapping bush 14 and is disposed in the radial direction on the outside of the free end 43.

On the opposite peripheral edge 27 of the wrapping bush 14, two steps 28, 29 are provided. The steps 28, 29 have a rectangular shape that is raised in the axial direction in relation to the peripheral edge 27.

FIG. 3 illustrates the side view of the wrapping bush from FIG. 2, wherein the peripheral edge 26 has inclines 30, 31 corresponding to the course of a right-handed turn in an area extending from the lateral right edge 34 of the slot 26 and corresponding to the course of a left-handed turn extending from the lateral left 33. The inclines extend to the recess 24, respectively.

FIG. 4 shows a spatial illustration of a spring sleeve 15 with a wrapping bush 14.

### FIG. 5 shows a view that is rotated by 90° in relation to FIG. 4.

FIG. 4 and FIG. 5 on the inside of the spring sleeve 15 show several notch-like depressions 35. The depressions 35 extend along the axial direction of the spring sleeve 15 across the entire length of the inside 49. The depressions 35 store lubricant.

The spring sleeve 15 on the periphery thereof comprises a continuous elongated slot 32 in the axial direction. The spring sleeve 15 comprises a supporting base collar 37 projecting in the radial direction, which collar is broken down into several substantially evenly distributed areas 51, 52, 53, 54, 55 across the circumference.

The areas 51, 52 are disposed mirror-symmetrically to each other on the edges of the slot 32. The area 53 is rotated clockwise by about 90° in relation to the area 52. The area 55 is disposed diametrically symmetrically opposed to the area 53 in the axial direction.

The areas 53, 55 comprise continuous recesses 38, 48 provided along the axial direction. The area 54 is disposed diametrically opposed to the slot 32 and in the radial direction on the free end thereof comprises a peripheral web 42. In the area 54, an area of a spring end support 41 projecting in the radial direction in relation to the web 42 is integrally formed.

On the outside 60 of the spring sleeve 15, two longitudinal steps 39, 57 are disposed diametrically opposed in the axial direction. They extend from the free peripheral edge, which is disposed axially opposite from the base collar. The step 39 comprises an inclined surface 40 in the axial direction. Proceeding from the start 58 of the inclined surface 40, it is raised with a positive incline to the end 59. Starting with the end 59, the step 39 is integrally formed in a planar fashion along the axial direction to its end. The step 57 has the same configuration as the step 39.

In FIG. 4 and FIG. 5 the wrapping bush 14 is placed on the spring sleeve 15 such that the slot 21 of the wrapping bush 14 is aligned with the slot 32 of the spring sleeve 15. The retaining steps 28, 29 provided on the wrapping bush 14 engage in a non-rotational manner in the recesses 38, 48 provided in the spring sleeve. The steps 39, 58 fasten the wrapping bush 14 via the recess 22, 23 so as not to rotate and slide on the spring sleeve 15.

The inclined surface 40 widens the wrapping bush 14 up to the engagement position during assembly with the spring sleeve 15. The wrapping bush 14 can slide easily across the steps 39, 57 until the steps 39, 57 completely engage in the recesses 22, 23 of the wrapping bush 14.

The wrapping bush 14 and the spring sleeve 15 have been produced together in a multi-component tool. This multi-component tool can be used to produce the wrapping bush 14 and the spring sleeve 15 separately by means of molding, the two parts being ejected separately after molding and assembled.

Optionally, depending on the design of the multi-component tool, the wrapping bush 14 and the spring sleeve 15 can be molded together in the tool so that the wrapping bush and the spring sleeve leave the tool already in the assembled state, as is shown for example in FIGS. 4 and 5. Although they are produced in the same tool, they remain separate parts, which can be displaced relative to each other.

The wrapping bush 14 is made of sphere-reinforced plastic, the plastic being a polyamide (PA 6.6.) that has been reinforced with glass spheres. The spring sleeve is made exclusively of a polyamide (PA 4.6).

FIG. 6 shows a spatial illustration of individual turns of a helical spring 11, which surround the wrapping bush 14 and the spring sleeve 15. One spring end 36 rests on the spring end support 41. A turn 13 of the helical spring 11 is supported on the web 42 of the supporting base collar 37 of the spring sleeve 15 in the radial direction. To this end, the turn 13 of the helical spring rests on the web 42, which ensures good force transmission properties. The spring end 36 is supported very well up to the detent area in the basic part 2 by the projecting spring end support 41 of the area 54. The turns 13, 44 envelope the wrapping bush 14.

Optionally, the helical spring 11 surrounds the wrapping bush 14 with more or less an entire turn, particularly with more than or equal to a half or 0.7 turn.

The mode of operation and operating principle of the exemplary embodiment illustrated in the drawing of an automatic belt tensioner according to the invention will be explained hereinafter.

A belt provided in a belt system of a motor vehicle is pre-stressed to a certain belt tension using an automatic belt tensioner.

The automatic belt tensioner 1 assumes a pre-stressed state so that the belt tensioner 1 automatically compensates for weather- and/or wear-related belt stretch.

In addition, the belt vibrates as a result of the revolutions of the belt in a belt system. These belt vibrations are transmitted to the deflecting arm 62 of the tensioning part 3.

By rotating the tensioning part 3 in relation to the basic part 2, the helical spring 11 is deflected and radially pre-stressed. As a result of the deflection of the helical spring 11, torque is applied to the spring, thus increasing or decreasing the inside diameter 45 of the helical spring 11. The torque of the helical spring tensions the tensioning part 3 about the common axis of rotation 4, with the deflecting arm 62 with the tension pulley 18 pre-stressing the belt to a defined belt tension.

The helical spring 11 produces a radial enveloping force that is distributed substantially evenly across the entire circumference of the wrapping bush 14. As a result, the outside diameter 46 of the wrapping bush and the outside diameter 65 of the spring sleeve 15 are reduced. The spring sleeve 15 is pushed against the friction surface 17 of the tensioning part 3 with the inside 16.

This creates a frictionally engaged connection between the friction surface 17 of the tensioning part 3 and the inside 16 of the spring sleeve 15. The frictionally engaged connection is so tight that the torque produced by the helical spring 11 can be transmitted to the tensioning part 3.

The radial enveloping force is sufficiently great for continuously transmitting the torque to the tensioning part 3 and for producing sufficiently high stability and friction on the adjoining components for vibration damping purposes.

The material of the wrapping bush 14 comprises reinforced plastic, as a result of which the enveloping turns 13, 44 of the helical spring 11 can mate particularly well with the wrapping bush 14, creating a very good force-fit connection. Additionally, the wrapping bush 14 is sufficiently tough and wear-resistant and can withstand the friction occurring from the spring sleeve 15 during the entire service life of the automatic belt tensioner 1. The reinforced plastic ensures that the wrapping bush 14 permanently maintains dimensional stability and is wear-resistant.

The spring turn 44 of the left-handed helical spring 11 comes in contact with an area on the chamfered peripheral edge 26, which comprises an incline 30 corresponding to the course of a left-handed turn. The enveloping force produced by the helical spring 11 is transmitted to the wrapping bush 14 nearly without loss of force and torque due to this support of the turn 44.

The same wrapping bush 14 can also be provided with right-handed helical springs. Depending on the tensioning direction, it is therefore universally usably at the installation location.

### For this reason, the wrapping bush 14 comprises on the chamfered peripheral edge 26 also an area, which is configured with the incline 31 corresponding to the course of a right-handed turn.

During the occurring relative motions between the turn 44 and the wrapping bush 14, the spring turn 44 can act particularly smoothly via the chamfer 25 on the chamfered peripheral edge 26.

The damping solid body and fluid friction is influenced by the radial enveloping force, the materials used for the wrapping bush and/or the spring sleeve and the lubricant. In a defined configuration of these parameters, the automatic belt tensioner 1 was statically excited by the belt, for example with a frequency of 2 Hertz, and the vibration was dampened by about 40%. If however the belt tensioner 1 was excited with a higher frequency, e.g. 20 Hertz, the friction damping effect increased to as much as 55%. The damping of the belt vibrations is stable throughout the entire service life. These values can vary when selecting the afore-mentioned parameters differently.

1. An automatic belt tensioner (1) comprising a basic part (2) that is connected to a tensioning part (3) so as to be rotatable about a common axis of rotation (4), a helical spring (11) that is connected to the basic part (2) and the tensioning part (3), and a wrapping bush (14), which is wrapped at least in some areas by a helical spring (11) at a radial enveloping force, characterized in that
the material of the wrapping bush (14) comprises reinforced plastic.

2. An automatic belt tensioner (1) according to claim 1, characterized in that
the material is fiber-reinforced, comprising particularly glass fibers for reinforcement.

3. An automatic belt tensioner (1) according to claim 1 or 2,
characterized in that
the material is plastic sphere-reinforced, comprising particularly glass spheres for reinforcement.

4. An automatic belt tensioner (1) according to any one of the claims 1 to 3,
characterized in that
the wrapping bush (14) can accommodate left- and right-handed helical springs (11).

5. An automatic belt tensioner (1) according to any one of the claims 1 to 4, characterized in that
a peripheral edge (26) of the wrapping bush (14) comprises inclines (30, 31) that correspond in one area to the course of a left-handed and in another area to the course of a right-handed spring turn.

6. An automatic belt tensioner (1) according to any one of the claims 1 to 5,
characterized in that
the wrapping bush (14) is enveloped by less than one full turn (13, 44) of the helical spring (11), particularly by more than or equal to a half or 0.7 turn.

7. An automatic belt tensioner (1) according to any one of the claims 1 to 6,
characterized in that
the wrapping bush (14) on the free end thereof (43) comprises a chamfered peripheral edge (26).

8. An automatic belt tensioner (1) according to at least one of the claims 1 to 7, the wrapping bush (14) surrounding a spring sleeve (15) at least in some areas,
characterized in that
a peripheral edge (27) of the wrapping bush (14) opposite the free end (43) comprises at least one retaining step (28, 29), which engages with a recess (38, 48) provided in the spring sleeve so as to resist rotation.

9. An automatic belt tensioner (1) according to at least one of the claims 1 to 8, the wrapping bush (14) surrounding a spring sleeve (15) at least in some areas,
characterized in that
the spring sleeve (15) on the inside (49) comprises at least one depression (35) for receiving lubricant.

10. An automatic belt tensioner (1) according to claim 9,
characterized in that
the depression (35) extends in the axial direction, particularly having a notched design in the cross-sectional view.

11. An automatic belt tensioner (1) according to at least one of the claims 1 to 10, a spring sleeve (15) that is surrounded by a wrapping bush (14) at least in some areas comprising a supporting base collar (37),
characterized in that
the supporting base collar (37) is broken down into several areas (51, 52, 53, 54, 55) that are distributed across the circumference.

12. An automatic belt tensioner (1) according to at least one of the claims 1 to 11, a spring sleeve (15) that is surrounded by a wrapping bush (14) at least in some areas comprising a supporting base collar (37),
characterized in that
at least one area (54) of the base collar (37) comprises a projecting spring end support (41).

13. An automatic belt tensioner (1) according to at least one of the claims 1 to 12, the wrapping bush (14) surrounding a spring sleeve (15) at least in some areas,
characterized in that
the wrapping bush (14) and the spring sleeve (15) have been produced together in a multi-component tool.
